(19) United States
(12) Patent Application Publication
(10) Pub. No.: US 2011/0142048 A1
(43) Pub. Date: Jun. 16, 2011

(54) SYSTEM AND METHOD FOR PROVIDING COMMON CARRIER SELECTION SERVICE IN DISTRIBUTION NETWORK

(75) Inventor: Seung Hyun YOON, Daejeon (KR)

(73) Assignee: Electronics and Telecommunications Research Institute, Daejeon (KR)

(21) Appl. No.: 12/911,188

(22) Filed: Oct. 25, 2010

(30) Foreign Application Priority Data
Dec. 10, 2009 (KR) 10-2009-0122684

(51) Int. Cl. H04L 12/56

(52) U.S. Cl. 370/392

(57) ABSTRACT

A distribution network system of a distribution network providing a common carrier selection service includes a distribution network device and a user portal server. The distribution network device detects a terminal that attempts to access the distribution network, determines whether or not the terminal has subscribed to the common carrier selection service, and connects the terminal to a common carrier as a service provider selected by the terminal according to the determination result.

### CROSS-REFERENCE TO RELATED APPLICATION

This application claims priority to and the benefit of Korean Patent Application No. 10-2009-0122684 filed in the Korean Intellectual Property Office on Dec. 10, 2009, the entire contents of which are incorporated herein by reference.

### BACKGROUND OF THE INVENTION

(a) Field of the Invention

The present invention relates to a system and method for providing a common carrier selection service in a distribution network, and more particularly, to a system and method for providing a common carrier selection service in a distribution network that is capable of allowing a user to select a common carrier of each service and apply the selected common carrier to a network in a distribution network.

(b) Description of the Related Art

Communication network services have been gradually integrated into an IP (Internet protocol)-based service and are currently entering a triple play service (TPS)/quadruple play service (QPS) stage in which premium services such as an Internet protocol television (IPTV), a voice over Internet protocol (VoIP), and the like, are provided through a single line.

Such current communication network services are managed by a common carrier to a home. For example, in the case of apartments, a common carrier that has made a contract for a main distribution frame chamber and a home (or premises) checks and manages the Internet service, so users generally subscribe to a single common carrier for various services in the form of a bundle.

Meanwhile, in Europe or the United States, etc., due to the atmosphere in which users' options are guaranteed and an industrial structure in which access providers (or local providers) and Internet service providers (ISPs) are separated, users can be provided with the Internet service, IPTV, and VoIP from different common carriers. In Korea, such a tendency is gradually increasing, and in line with this, users' rights for selecting different common carriers for each service are gradually being considered important.

However, despite the gradual increase in the importance of users' rights for selecting different common carriers for each service, domestically, one common carrier still bundles the Internet access service, the IPTV, and the VoIP, as well as physical lines, to provide services. In particular, the functions of performing an access authentication, providing a use authority, providing an IP address, and the like, and the core functions for starting a service, are provided by an ISP through equipment called a broadband remote access server/ broadband network gateway (BRAS/BNG), so it is not easy for users to be provided with each service from different carriers or change a current common carrier to a different common carrier.

Therefore, a technique for selecting common carriers by the services and applying them in a distribution network is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for providing a common carrier selection service in a distribution network having advantages of allowing a user to select a common carrier for each service and applying the selected common carrier to a network.

An exemplary embodiment of the present invention provides a method for providing a common carrier selection service in a distribution network of a distribution network system, including:
receiving an access request message through a terminal of a home network; determining whether or not the terminal is a terminal of a user who has subscribed to the common provider selection service by using the access request message; if the terminal is a terminal of a user who has subscribed to the common carrier selection service, connecting the terminal to a service provider of a common carrier selected by the terminal; and if the terminal is a terminal of a new user which has not subscribed to the common provider selection service, assigning a temporary IP address to the terminal and transmitting the same.

Another embodiment of the present invention provides a method for providing a common carrier selection service by a user portal server of a distribution network system including a distribution network device that assigns a temporary IP address, including:
determining whether or not a temporary IP address has been assigned to a terminal that has accessed a distribution network; if a temporary IP address has not been assigned to the terminal, determining whether or not the terminal requests changing to a common carrier as a new service provider and providing a service allowing the terminal to access the new common carrier; and when a temporary IP address has been assigned to the terminal, performing a new subscription procedure upon determining that the terminal is a terminal of a new user or determining that a MAC address of the terminal has been changed or performing a terminal changing procedure to alter information of the terminal.

Yet another embodiment of the present invention provides a distribution network system of a distribution network providing a common carrier selection service, including:
a distribution network device detecting a terminal attempting an access to the distribution network, determining whether or not the terminal has subscribed to the common carrier selection service, and connecting the terminal to a service provider of a common carrier selected by the terminal according to the result obtained by determining whether or not the terminal has subscribed to the common carrier selection service; and a user portal server providing a change-related portal service allowing a user who has subscribed to the common carrier selection service to change the common carrier, and providing a subscription-related portal service when a new user accesses to thus allow the user to subscribe to the common carrier selection service, wherein when the terminal has not subscribed to the common carrier selection service, the distribution network device assigns a temporary IP address to the terminal.

### BRIEF DESCRIPTION OF THE DRAWINGS

FIG. 1 is a schematic view showing an example of locations of distribution network devices in a distribution network according to an exemplary embodiment of the present invention.

FIG. 2 is a schematic view showing a distribution network system according to an exemplary embodiment of the present invention.

FIG. 3 is a flowchart illustrating the process of providing a common carrier selection service through the distribution network device of the distribution network system according to an exemplary embodiment of the present invention.

FIG. 4 is a flowchart illustrating the process of providing a common carrier selection service through a user portal server of the distribution network system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

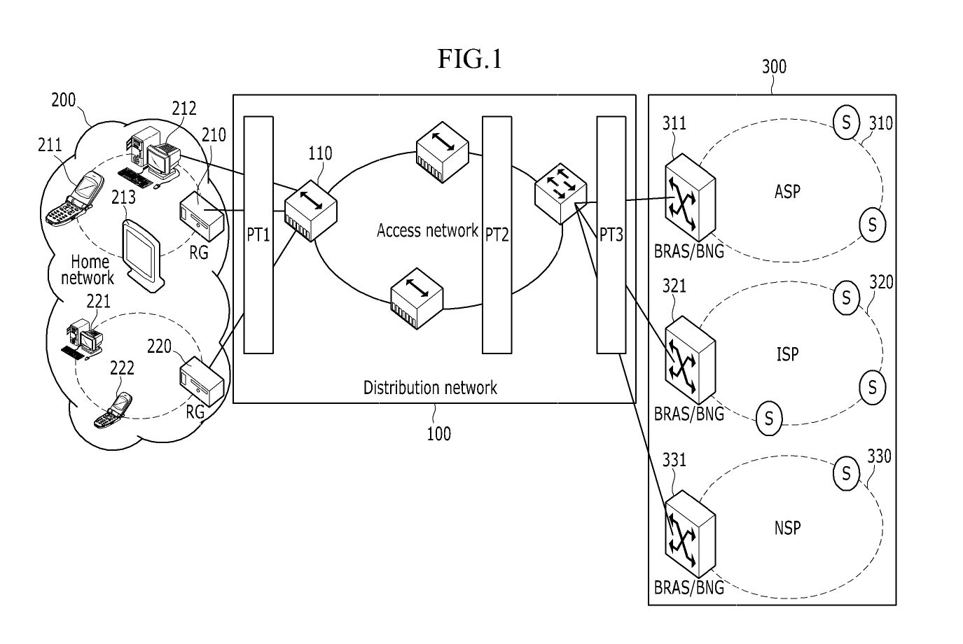

FIG. 1 is a schematic view showing an example of locations of distribution network devices in a distribution network according to an exemplary embodiment of the present invention.

As shown in FIG. 1, a distribution network 100 according to an exemplary embodiment of the present invention is an access network including a distribution network device (not shown) connecting a user that has accessed the distribution network 100 to a common carrier 300. The distribution network device herein will be described in detail later. The access network may cover from a point following home equipment to a point of presence (POP) of the common carrier 300, namely, immediately before broadband remote access server (BRAS)/broadband network gateway (BNG) 311, 321, and 331.

A home network 200 includes residential gateways (RGs) (or home gateways) 210 and 220 and user terminals 211, 212, 213, 221, and 222 connected to the home gateways 210 and 220. Here, the RGs 210 and 220 connect the user terminals 211, 212, 213, 221, and 222 to an external communication network.

The common carrier 300, which is a service provider providing an Internet service through the user terminals 211, 212, 213, 221, and 222 connected to the distribution network 100, includes an application service provider (ASP) 310, an Internet service provider (ISP) 320, and a network service provider (NSP) 330.

The ASP 310, including the BRAS/BNG 311, provides various applications required for corporate management. The ISP 320, including the BRAS/BNG 321, provides a simple Internet service. The NSP 330 transmits all traffic, without being limited to an Internet access service, including an IPS backbone service, a dedicated line service, and the like. The NSP 330 may not include the BRAS/BNG 331.

The BRAS/BNGs 311, 321, and 331, which are inter-network interworking devices, interwork with the distribution network 100 to allow the user to access the common carrier 300, i.e., the ASP 310, the ISP 320, and the NSP 330, selected by the user.

Distribution network devices may be located at various first to third points PT1, PT2, and PT3 in the distribution network 100. For example, first, the distribution network device may be installed at the first point PT1 between an access node 110, i.e., entrance equipment of the user 200 side and home networks 210 and 220. Second, the distribution network device may be disposed at the second point PT2, not at a particular location or equipment, in the distribution network 100 in order to distribute a corresponding function to the access network. Third, the distribution network device may be installed at the third point PT3 between the distribution network 100 and the respective BRAS/BNGs 311, 321, and 331 of the common carrier 300 in consideration of a passive optical network (PON) and an FTTH environment.

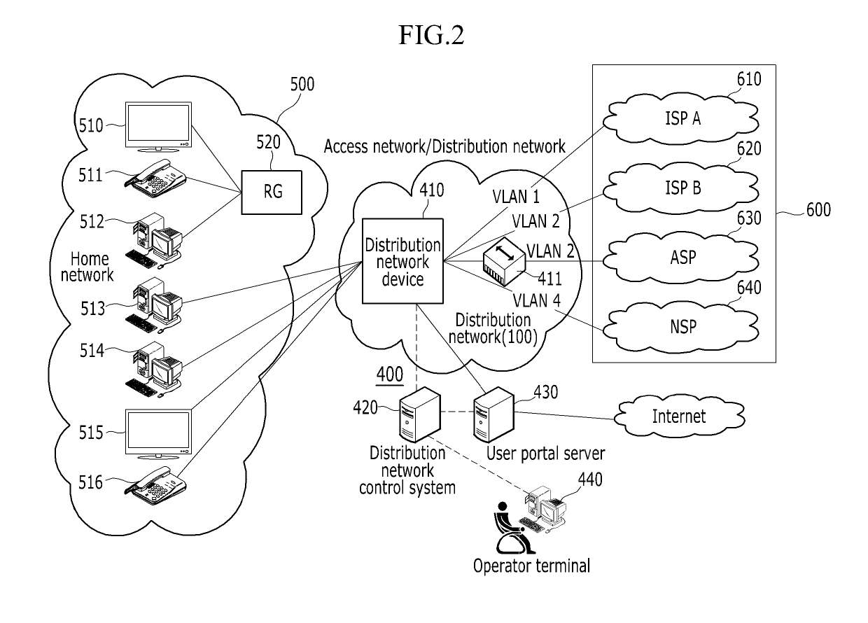

A distribution network system including the distribution network device according to an exemplary embodiment of the present invention will now be described in detail with reference to FIGS. 2 to 4.

FIG. 2 is a schematic view showing a distribution network system according to an exemplary embodiment of the present invention.

As shown in FIG. 2, a distribution network system 400 of a distribution network 100 according to an exemplary embodiment of the present invention interworks between a home network 500 and a common carrier 600 to provide a common carrier selection service to allow the user to select a common carrier 600 according to each service. The common carrier selection service according to an exemplary embodiment of the present invention allows a user who has subscribed to the common carrier selection service to select the ASP 310, the ISP 320, and the NSP 330 by the services, thus providing a selected service to the user. In this case, it is assumed that a distribution network device 410 of the distribution network system 400 is installed at the first point PT1 as described above with reference to FIG. 1, namely, between the home network 500 and an access node 411, which is entrance equipment of the user side.

The home network 500 includes user terminals 510 to 516 and an RG 520. In this case, the terminals 510 to 512 are connected to the distribution network 100 via the RG 520, and the remaining terminals 513 to 516 are directly connected to the distribution network device 410 of the distribution network 100. In both cases, the terminals 510 to 516 are connected to the common carrier 600 by using an Ethernet technique.

The distribution network system 400 includes the distribution network device 410, a distribution network control system 420, a user portal server 430, and an operator terminal 440.

When the user who has subscribed to the common carrier selection service requests access to the distribution network 100 through the terminals 510 to 516, the distribution network device 410 checks information regarding a user terminal (referred to as “user terminal information”, hereinafter) based on a port number and a media access control (MAC) address of the distribution network device accessed by the terminals 510 to 516, and connects the user terminal to the corresponding common carrier 600. When it is detected that a terminal (not shown) of a new user who has not selected the common carrier 600 because he has not subscribed to the common carrier selection service requests access to the distribution network 100, the distribution network device 410 assigns a temporary IP address to allow the terminal of the new user to access the user portal server 430. In the present exemplary embodiment, the distribution network device 410 assigns the IP address to the terminal of the new user, but the present invention is not limited thereto and the distribution network control system 420 may perform the same role.

When terminals such as the terminals 513 to 516 are directly connected individually to the distribution network device 410, the distribution network device 410 can recognize the user terminals 513 to 516 based on port numbers without using a MAC address or the like, and information of the terminals 513 to 516. Meanwhile, when terminals such as the terminals 510 to 512 are connected to the distribution network device 410 via the gateway 520, the distribution network device 410 recognizes the terminals 510 to 512 based on the MAC addresses because the distribution network device 410 cannot recognize the individual terminals based on the port numbers. Namely, when the terminals such as the terminals 513 to 516 of the home network 500 are not directly connected to the distribution network device 410, it is difficult for the distribution network device 410 to recognize the user terminals based on their port numbers so the distribution network device 410 recognizes the terminals based on their MAC addresses, and in this case, connected port number information can also be used. In this manner, the distribution network device 410 uses the port numbers and the MAC addresses as identifiers together.

The distribution network device 410 connects the user terminals 510 to 516 to the common carrier 600 by using VLAN1 (Virtual LAN1)-VLAN4 based on the port numbers or the MAC addresses, but the present invention is not limited thereto and the distribution network device 410 may connect the user terminals 510 to 516 to the common carrier 600 by mapping a MAC/port to an S-VLAN, a provider backbone bridging (PBB), or a multiprotocol label switching (n MPLS) tunnel, as well as through simple VLAN mapping.

The distribution network control system 420 directly controls the distribution network device 410 and maintains and manages relevant information in the distribution network device 410.

The user portal server 430 provides a relevant portal service for a subscription and changing to the user who has subscribed to the common carrier selection service to allow the user to select the common carrier 600 by the services through a web. When an operator accesses the user portal server 430 through the operator terminal 440, the user portal server 430 provides a portal service to allow for adding, deleting, and changing user terminal information. Also, when a new user who has been assigned a temporary IP address by approaching the distribution network device 410 accesses the user portal server 430, the user portal server 430 provides a subscription-related portal service to allow the new user to subscribe to the common carrier selection service and select a common carrier. In the present exemplary embodiment, the common carrier 600 is selected by using the user terminals 510 to 516 that are available for a web interface, but the present invention is not limited thereto and a terminal that is unavailable for the Web interface can perform subscription and changing offline or through a telephone.

The common carrier 600, which is a service provider providing the Internet, VoIP, IPTV, a dedicated line service, and the like to the corresponding user through the terminals 510 to 516 that have accessed the distribution network 100, includes an ISP A 610, an ISP B 620, an ASP 630, and an NSP 640. Here, the ISP A 610, the ISP B 620, the ASP 630, and the NSP 640 perform the same function as that of the common carrier 300 illustrated in FIG. 1, so a detailed description thereof will be omitted.

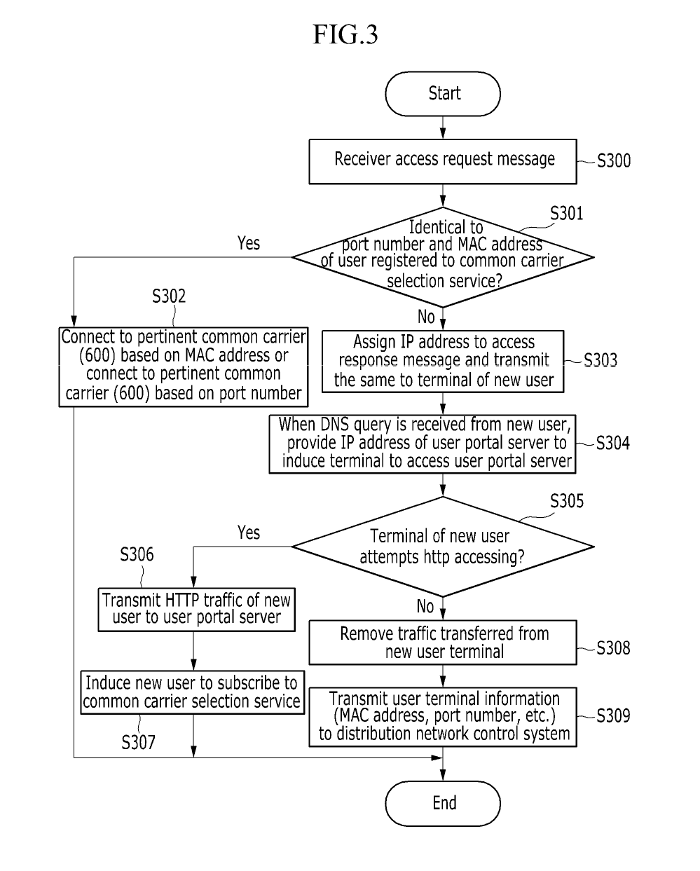

FIG. 3 is a flowchart illustrating the process of providing the common carrier selection service through the distribution network device of the distribution network system according to an exemplary embodiment of the present invention.

As shown in FIG. 3, in order to access the distribution network system 400 according to an exemplary embodiment of the present invention, the user delivers an access request message based on a dynamic host configuration protocol (DHCP) through the terminals 510 to 516 of the home network 500. The distribution network device 410 receives the access request message based on the DHCP from the terminals 510 to 516 (S300). The distribution network device 410 detects a port number and a MAC address of a corresponding terminal by using the access request message, and checks the detected port number and the MAC address from the user terminal information registered to the common carrier selection service in order to determine whether or not the terminal is a terminal of a registered user or a terminal of a new user (S301).

When the same port number and MAC address are detected from the user terminal information according to the checking result, the distribution network device 410 determines that a terminal of an already registered user has accessed and connects the terminal to a corresponding service provider of the common carrier 600 through VLAN mapping based on the MAC address or connects the terminal to a corresponding service provider of the corresponding common carrier 600 through VLAN mapping based on the port number (S302). Namely, the user is assigned the IP address from the common carrier 600 selected by using its terminal without control of the distribution network device 410, and is given the authority of authentication and use.

Meanwhile, when the same port number and MAC address are not detected from the user terminal information according to the checking result, the distribution network device 410 determines that a terminal of a new user has accessed, and it generates an access response message in response to the access request message, assigns a temporary IP address to the access response message, and transmits the same to the terminal of the new user (S303).

When a domain name system (DNS) query is transferred from the terminal of the new user that has been assigned the IP address, the distribution network device 410 provides an IP address of the user portal server 430 to the terminal to induce the terminal to access the user portal server 430 (S304).

The distribution network device 410 determines whether or not the terminal of the new user that has accessed the user portal server 430 has transferred a website address based on a hypertext transfer protocol (http) in order to request access to a website (S305).

When the terminal of the new user attempts http-based website accessing, the distribution network device 410 transmits a packet received from the terminal of the new user to the user portal server 430, regardless of a requested website address, in order to induce the new user to subscribe to the common carrier selection service (S306, S307).

Meanwhile, when traffic transmission rather than http-based accessing is attempted by the terminal of the new user, the distribution network device 410 removes the relevant packet so that the relevant packet cannot be transmitted to the user portal server 430, for the reason of security or the like (S308). In this case, the distribution network device 410 may transmit the user terminal information (MAC address and port number) related to the terminal of the new user and traffic information to the distribution network control system 420, so as to be used for inducing a subscription offline or through a telephone later (S309).

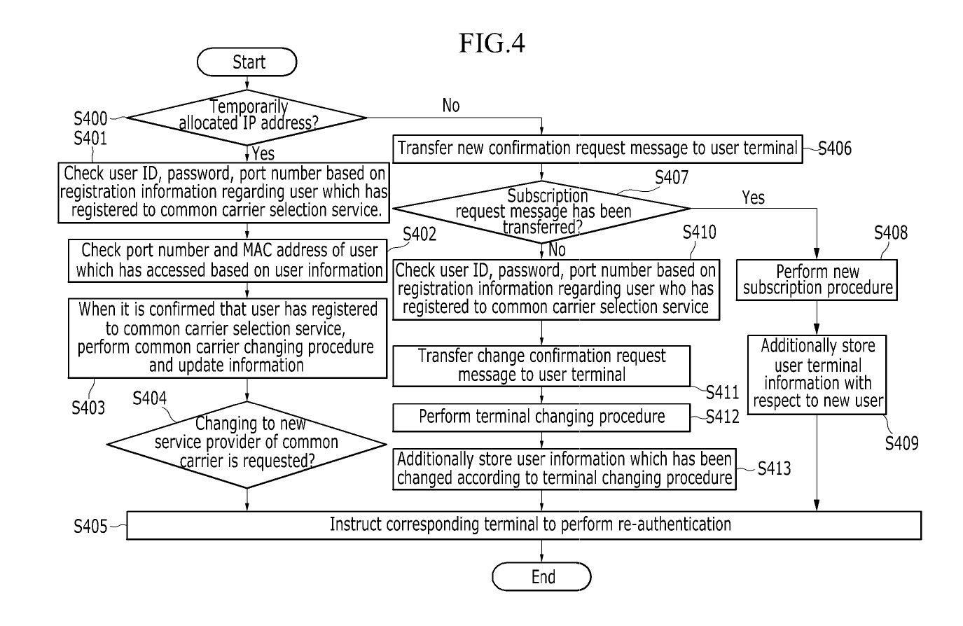

FIG. 4 is a flowchart illustrating the process of providing the common carrier selection service through the user portal server of the distribution network system according to an exemplary embodiment of the present invention.

As shown in FIG. 4, the user portal server 430 of the distribution network system 400 according to an exemplary embodiment of the present invention checks whether or not an address is a temporary IP address in order to determine whether or not the user has accessed through the external Internet or through the distribution network device 410 (S400).

When the address is not a temporary IP address, the user portal server 430 determines that the user has accessed through the external Internet rather than accessing through the distribution network device 410 after having been registered to a common carrier such as an IPS or the like. The user portal server 430 checks an identifier (ID) and a password of the user based on registration information regarding the user who has subscribed to the common carrier selection service (S401). Here, the registration information may include an ID set by the user who has subscribed to the common carrier selection service, and the ID and the password of the user, and the like, and that is stored in the user portal server 430. Further, the user portal server 430 checks the port number and MAC address of the user terminal that has accessed based on the user terminal information stored in the distribution network device 410 for the purpose of security (S402). For example, the user portal server 430 checks whether or not a port number and a MAC address that are identical to the IP address of the user who has accessed based on the user terminal information stored in the distribution network device 410 have been stored.

When the registration information and the user terminal information are identical so the accessed user is confirmed as a user who has registered to the common carrier selection service, the user portal server 430 performs a common carrier changing procedure and stores information regarding a common carrier to which changing has been requested (S403).

The user portal server 430 may receive a request for changing a current service provider, e.g., the ISP A 610, among service providers of the common carrier 600, to a new service provider, e.g., the ISP B 620, from the user (S404). In the present exemplary embodiment, it is assumed that the user request changing from the current ISP A 610, among the service providers of the common carrier 600, to the ISP B 620, a new service provider. When the user requests changing from the previously selected service provider to the new service provider with respect to a particular service, the user portal server 430 may instruct the user terminal to perform re-authentication in order to access the new service provider. In this case, the terminal newly receives an IP address from the new service provider and is connected (S405).

Meanwhile, when a temporary IP address has been allocated and the terminal has accessed the user portal server 430 directly from the distribution network device 410, the user portal server 430 determines that the accessed terminal of the user is a terminal of a new user or that the MAC address of the terminal has been changed for the reason of a terminal change, a network card change, and the like.

In order to determine whether or not the accessed user terminal is a terminal of a new user, first, the user portal server 430 transfers a new confirmation request message to the terminal of the corresponding user (S406).

When a subscription request message is transferred from the user terminal in response to the new confirmation request message (S407), the user portal server 430 performs a new subscription procedure with respect to the accessed user terminal (S408). Further, the user portal server 430 stores the additional user terminal information with respect to the new subscriber (S409). When the new user selects a common carrier as a service provider, the user portal server 430 stores the changed or added information as in step S405 and instructs the terminal of the new user to perform re-authentication so as to be connected to the selected service provider.

Meanwhile, when it is determined that the user is already a subscribed user, the user portal server 430 authenticates the subscribed user based on a user ID and password, an identified port number, and the like (S410), and the user portal server 430 transfers a change confirmation request message to the corresponding user terminal in order to determine whether or not the MAC address of the accessed user terminal has been changed (S411). When a change confirmation message is transferred from the user terminal in response to the change confirmation request message, the user portal server 430 performs a terminal changing procedure of changing the terminal information (MAC address) of the accessed user and storing the same (S412). Also, the user portal server 430 additionally stores user terminal information regarding the user terminal that has been changed according to the terminal changing procedure (S413). In addition, when the terminal having the changed MAC address requests changing to or adding a new common carrier, the user portal server 430 may additionally perform a common carrier changing procedure. The user portal server 430 may instruct the terminal to perform re-authentication so as to access the common carrier.

According to an exemplary embodiment of the present invention, because a user can select a common carrier for each service online and apply the same in a network. Thus, the user can freely select a common carrier.

The exemplary embodiments of the present invention as described are not implemented only through a device or a method, but may be implemented through a program that can realize a function corresponding to the configuration of the exemplary embodiments of the present invention or a recording medium storing the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a common carrier selection service in a distribution network of a distribution network system, including:
receiving an access request message through a terminal of a home network;
determining whether or not the terminal is a terminal of a user who has subscribed to the common provider selection service by using the access request message;
if the terminal is a terminal of a user who has subscribed to the common carrier selection service, connecting the terminal to a service provider of a common carrier selected by the terminal; and
if the terminal is a terminal of a new user who has not subscribed to the common provider selection service, assigning a temporary IP address to the terminal and transmitting the same.

2. The method of claim 1, wherein the assigning of the temporary IP address comprises,
when a domain name system (DNS) query is delivered from the terminal of the new user, providing the temporary IP address to induce the terminal to access a user portal server in order to provide a portal service for a subscription to the common carrier selection service to the terminal.

3. The method of claim 1, wherein the assigning of the temporary IP address comprises:
determining whether or not the terminal of the new user attempts to access a website;
when the terminal of the new user attempts to access a website, connecting the terminal of the new user to a user portal server to register the terminal to the common carrier selection service; and
when the terminal of the new user generates traffic other than a website access attempt, storing user terminal information regarding the terminal of the new user.

4. The method of claim 1, wherein the determining of whether or not the terminal is a terminal of a user who has subscribed to the common carrier selection service comprises:
detecting a port number and a MAC address of the terminal by using the access request message;
when the port number and the MAC address of the terminal are detected from the user terminal information of the user who has subscribed to the common carrier selection service, determining that the terminal is a terminal of a user who has subscribed to the common carrier selection service; and
when the port number and the MAC address of the terminal are not detected from the user terminal information of the user who has subscribed to the common carrier selection service, determining that the terminal is a terminal of the new user.

5. The method of claim 4, wherein the connecting of the terminal of the user to the service provider comprises
connecting the terminal of the user to the service provider of the common carrier that has been selected by the terminal based on the port number or the MAC address of the terminal.

6. A method for providing a common carrier selection service by a user portal server of a distribution network system including a distribution network device that assigns a temporary IP address, the method comprising:
determining whether or not a temporary IP address has been assigned to a terminal that has accessed a distribution network;
if a temporary IP address has not been assigned to the terminal, determining whether or not the terminal requests changing to a common carrier as a new service provider and providing a service allowing the terminal to access the new common carrier; and
when a temporary IP address has been assigned to the terminal, performing a new subscription procedure upon determining that the terminal is a terminal of a new user, or determining that a MAC address of the terminal has been changed or performing a terminal changing procedure to alter information of the terminal.

7. The method of claim 6, further including
instructing the user terminal to perform re-authentication in order to access the new service provider,
wherein the instructing includes:.
checking identification (ID) and a password of the terminal based on registration information of the user who has subscribed to the common carrier selection service;
checking a port number and the MAC address of the terminal based on user terminal information of the user who has subscribed to the common carrier selection service; and
when the ID of the terminal and an ID and a password of the user are identical to the registration information of the user and when the port number and the MAC address of the terminal are identical to the user terminal information, performing a common carrier changing procedure, storing information regarding a service provider of a common carrier the terminal has requested to change to or add, and instructing re-accessing.

8. The method of claim 6, wherein the performing of the terminal changing procedure comprises:
transferring a new confirmation message to the terminal;
receiving a subscription request message from the terminal in response to the new confirmation message; and
determining that the terminal is the terminal of the new user and performing the new subscription procedure.

9. The method of claim 8, wherein the performing of the new subscription procedure comprises,
when the new user requests changing to or adding the common carrier as a new service provider, instructing the terminal of the new user to perform re-authentication so as to access the common carrier as the new service provider the terminal has requested to change to or add.

10. The method of claim 6, wherein the performing of the terminal changing procedure comprises:
inquiring about the ID of the terminal and the ID and password of the user to confirm the same;
transferring a change confirmation request message to the terminal;
receiving a terminal change confirmation message from the terminal in response to the change confirmation request message; and
determining that the MAC address of the terminal has been changed and performing the terminal changing procedure.

11. The method of claim 10, wherein the performing of the terminal changing procedure comprises,
when the terminal whose MAC address has been changed requests changing to or adding the common carrier as a new service provider, instructing the terminal having the changed MAC address to perform re-authentication so as to access the common carrier the terminal has requested to change to or add as a new service provider, to be assigned a new IP address, and to be authenticated for access.

12. A distribution network system of a distribution network providing a common carrier selection service, the system comprising:
a distribution network device for detecting a terminal attempting access to the distribution network, determining whether or not the terminal has subscribed to the common carrier selection service, and connecting the terminal to a service provider of a common carrier selected by the terminal according to a result obtained by determining whether or not the terminal has subscribed to the common carrier selection service; and
a user portal server for providing a change-related portal service allowing a user who has subscribed to the common carrier selection service to change the common carrier, and providing a subscription-related portal service when a new user accesses to thus allow the user to subscribe to the common carrier selection service,
wherein when the terminal has not subscribed to the common carrier selection service, the distribution network device assigns a temporary IP address to the terminal.

13. The system of claim 12, wherein when a port number and a MAC address of the terminal are detected from user terminal information of the common carrier selection service, the distribution network device determines that the terminal has subscribed to the common carrier selection service and connects the terminal to a service provider of a common carrier selected by the terminal based on the port number and the MAC address of the terminal.

14. The system of claim 12, wherein if the port number and the MAC address of the terminal are not detected from the user terminal information of the common carrier selection service, the distribution network device determines that the terminal has not subscribed to the common carrier selection service and assigns the temporary IP address.

15. The system of claim 12, wherein when the terminal is not assigned a temporary IP address, the user portal server inquires of the terminal regarding whether or not the terminal wants to change to or add the common carrier as a new service provider, and provides a service to allow the terminal to access the common carrier as a new service provider.

16. The system of claim 15, wherein when the terminal requests changing to the common carrier as a new service provider, the user portal server performs a common carrier changing procedure and stores information regarding the service provider the terminal has requested to newly change to or add.

17. The system of claim 12, wherein when the terminal has assigned a temporary IP address, the user portal server determines that the terminal is a terminal of a new user and performs a new subscription procedure.

18. The system of claim 12, wherein when the terminal has assigned a temporary IP address, the user portal server determines that the MAC address of the terminal has been changed, and performs a terminal changing procedure.
